(19) United States
(12) Patent Application Publication
(10) Pub. No.: US 2006/0168890 A1
(43) Pub. Date: Aug. 3, 2006

(54) Refrigerator

(75) Inventor: Young Jin Cho, Gwangju-City (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/269,557

(22) Filed: Nov. 9, 2005

(30) Foreign Application Priority Data
Jan. 14, 2005 (KR) 2005-3919

(51) Int. Cl. E05D 15/50

(52) U.S. Cl. 49/193

(57) ABSTRACT

A refrigerator having an auxiliary door installed on a door for allowing a user to take stored goods from the refrigerator without opening the door. The refrigerator includes a main body, one surface of which is opened, provided with a storage chamber therein; a door for opening and closing the storage chamber; an opening formed through one door; an auxiliary door, the lower end of which is rotatably installed at the lower end of the opening of the door, for opening and closing the opening; and hinge devices which rotatably mounts the auxiliary door at the opening. Since the hinge device elastically supports the auxiliary door from the point of time when the auxiliary door is opened to a designated angle, the opening speed of the auxiliary door is gradually increased until the auxiliary door is opened to the designated angle, and is decreased due to the elastic support of the auxiliary door by the hinge device from the point of time when the auxiliary door is opened above the designated angle. The hinge device reduces impact applied to the auxiliary door when the auxiliary door is completely opened.

### CROSS-REFERENCE TO RELATED APPLICATION

This application claims priority from Korean Patent Application No. 2005-3919, filed Jan. 14, 2005, in the Korean Intellectual Property Office, the disclosure of which is incorporated herein by reference.

### BACKGROUND OF THE INVENTION

1. Field of the Invention

The present invention relates to a refrigerator and, more particularly, to a refrigerator having an auxiliary door installed on a door for allowing a user to take stored food from the refrigerator without opening the door.

2. Description of the Related Art

Generally, refrigerators are apparatuses for storing goods, such as foods, at a low temperature using components of a refrigerating cycle.

Some recent big-sized refrigerators comprise an opening formed in a door for allowing a user to put or take goods into and out of a chamber without opening the door, and an auxiliary door provided at the opening for opening and closing the opening.

The lower end of the auxiliary door is hinged to the lower end of the opening of the door so that the auxiliary door is vertically rotated to be opened to an angle of 90°. The opening speed of the auxiliary door gradually increases due to gravity, and rapidly decreases close to zero at the point of time when the auxiliary door is completely opened nearly to the angle of 90°, thereby causing impact to the auxiliary door.

Korean Laid-open Publication No. 10-2004-0080070 discloses a refrigerator, which has an oil damper applied to a hinge unit of an auxiliary door so that the opening speed of the auxiliary door is decreased by the oil damper, thereby preventing impact from being applied to the auxiliary door when the auxiliary door is completely opened.

However, since the opening speed of the auxiliary door of the above conventional refrigerator is continuously decreased by the oil damper from the point of time when the auxiliary door starts to be opened to the point of time when the auxiliary has been completely opened, it takes a long time to open the auxiliary door.

### SUMMARY OF THE INVENTION

Therefore, one aspect of the invention is to provide a refrigerator, in which the opening speed of an auxiliary door increases, and impact, applied to the auxiliary door when the auxiliary door is opened, is reduced.

In accordance with one aspect, the present invention provides a refrigerator comprising: a main body, one surface of which is opened, provided with a storage chamber therein; at least one door for opening and closing the storage chamber; an opening formed through one door; an auxiliary door, a lower end of which is rotatably installed at a lower end of the opening of the door, for opening and closing the opening; and a hinge device which rotatably mounts the auxiliary door at the opening, and elastically supports the auxiliary door from a point of time when the auxiliary door is opened to a designated angle to reduce the opening speed of the auxiliary door.

The hinge device may comprise a first cam member rotatably installed at one side of the opening and elastically supported by an elastic member exhibiting elastic force, and a second cam member installed on the auxiliary door, rotated together with the rotation of the auxiliary door and contacting the first cam member to transmit force to the first cam member from the point of time when the auxiliary door is opened to the designated angle.

The hinge device may further comprise a first fixing bracket fixed to one side of the opening of the door such that the first cam member is rotatably installed on the first fixing bracket, a second fixing bracket fixed to the auxiliary door such that the second cam member is installed on the second fixing bracket, and a hinge shaft passing through the first cam member and provided with one end rotatably installed at the first fixing bracket and an other end rotatably installed at the second fixing bracket.

A first cam portion and a second cam portion may be respectively protruded from the first cam member and the second cam member in the anti-radial direction, and contact each other from the point of time when the auxiliary door is opened to the designated angle.

The elastic member may include a torsion spring comprising an elastic portion having the shape of a coil and exhibiting elastic force in the circumferential direction, and a pair of support portions respectively extended from both ends of the elastic portion and fixed to the first fixing bracket and the first cam member.

A cam hole for rotatably installing the second cam member therein may be formed in the first cam member, and a first cam portion and a second cam portion, which contact each other according to the rotation of the auxiliary door, may be respectively protruded from the inner cylindrical surface of the cam hole and the outer cylindrical surface of the second cam member.

The hinge device may further comprise a first fixing bracket fixed to one side of the opening of the door and provided with a hinge hole for rotatably installing the first cam member therein, and a second fixing bracket fixed to one side of the auxiliary door and provided with the second cam member installed thereon for rotating the second cam member together with the rotation of the auxiliary door.

The elastic member may include a plate spring wound on the outer cylindrical surface of the first cam member and provided with one end latched onto a first latch portion formed in the inner cylindrical surface of the first fixing bracket and the other end latched onto a second latch portion formed in the outer cylindrical surface of the first cam member.

A bush having the shape of a ring, for allowing the second cam member to be smoothly rotated even when the second cam member contacts the front end of the first cam portion, may be installed at the front end of the first cam portion.

In accordance with another aspect, the present invention provides a refrigerator comprising: a main body, one surface of which is opened, provided with a storage chamber therein; at least one door for opening and closing the storage chamber; an opening formed through one door; an auxiliary door, a lower end of which is rotatably installed at a lower end of the opening of the door, for opening and closing the opening; and a hinge device which rotatably mounts the auxiliary door on the door, wherein the hinge device comprises a first cam member rotatably installed at one side of the opening of the door, a second cam member installed at one side of the auxiliary door, rotated together with the rotation of the auxiliary door, and contacting the first cam member according to the opening angle of the auxiliary door, and an elastic member for elastically supporting the first cam member in a circumferential direction.

In accordance with yet another aspect, the present invention provides a refrigerator comprising: a main body, one surface of which is opened, provided with a storage chamber therein; at least one door for opening and closing the storage chamber; an opening formed through one door; an auxiliary door, a lower end of which is rotatably installed at a lower end of the opening of the door, for opening and closing the opening; and a hinge device which rotatably mounts the auxiliary door at the opening, and elastically supports the auxiliary door from the point of time when the auxiliary door is opened to a designated angle to reduce the opening speed of the auxiliary door, wherein the hinge device comprises a first cam member provided with a first cam portion having the shape of a wedge and installed at one side of the opening, and a second cam member provided with a second cam portion having the shape of a wedge and installed at one side of the auxiliary door so that the second cam portion contacts the first cam portion when the auxiliary door is opened outside a designated range.

### BRIEF DESCRIPTION OF THE DRAWINGS

These and/or other aspects and advantages of the invention will become apparent and more readily appreciated from the following description of the exemplary embodiments, taken in conjunction with the accompanying drawings, in which:

FIG. 1 is a perspective view of a refrigerator of the present invention;

FIG. 2 is a longitudinal sectional view of the refrigerator of the present invention;

FIG. 3 is a perspective view of a hinge device applied to an auxiliary door of a refrigerator in accordance with a first embodiment of the present invention;

FIG. 4 is an exploded perspective view of the hinge device applied to the auxiliary door of the refrigerator in accordance with the first embodiment of the present invention;

FIG. 5 is a schematic view illustrating operations of a first cam member and a second cam member when the auxiliary door of the refrigerator of the present invention is opened;

FIG. 6 is a schematic view illustrating an auxiliary door and a hinge device of a refrigerator in accordance with a second embodiment of the present invention; and

FIG. 7 is a side view of the hinge device of the refrigerator in accordance with the second embodiment.

### DETAILED DESCRIPTION OF THE ILLUSTRATIVE, NON-LIMITING EMBODIMENTS OF THE INVENTION

Reference will now be made in detail to the illustrative, non-limiting embodiments of the present invention, an example of which is illustrated in the accompanying drawings, wherein like reference numerals refer to like elements throughout. The embodiments are described below to explain the present invention by referring to the annexed drawings.

Hereinafter, a refrigerator in accordance with the first embodiment of the present invention will be described with reference to the annexed drawings.

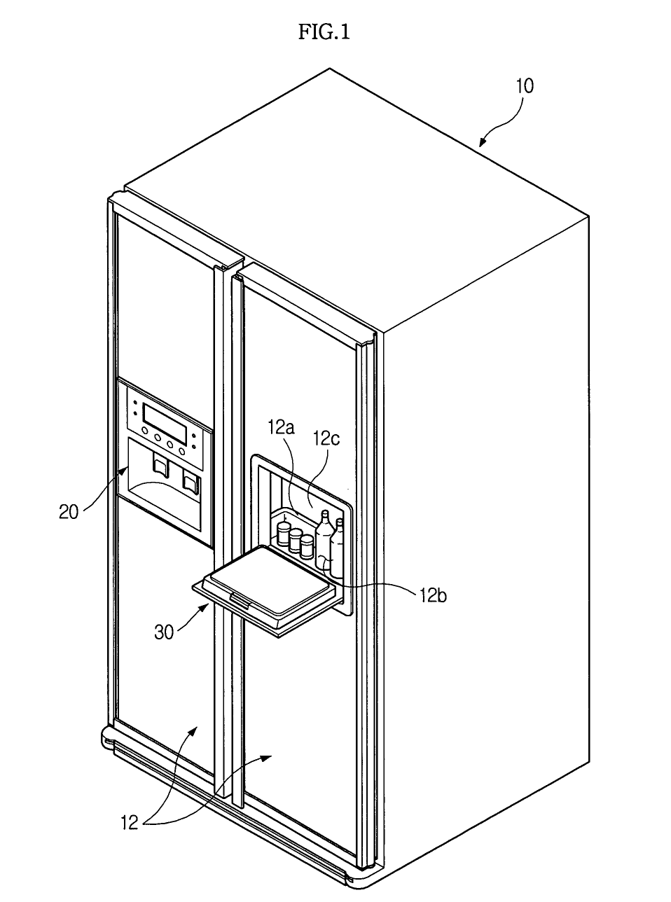

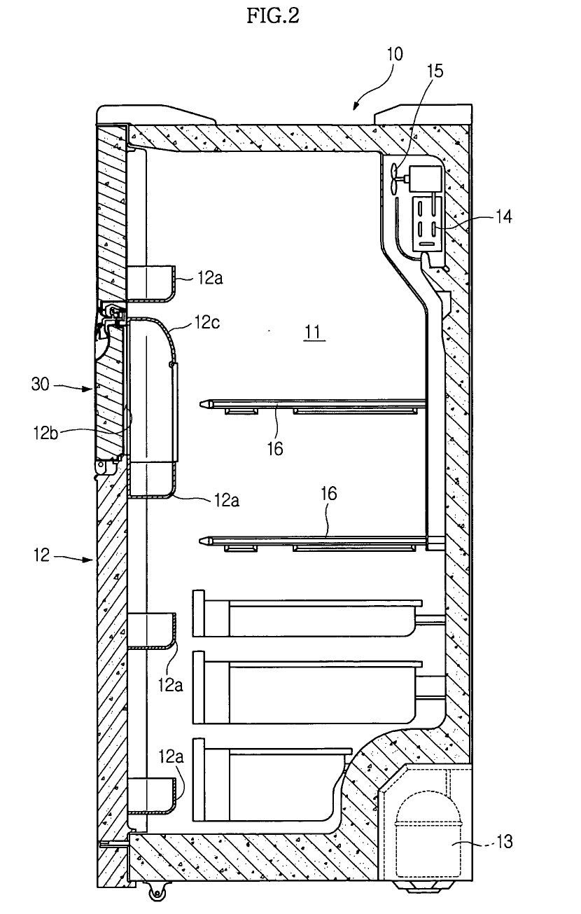

As shown in FIGS. 1 and 2, the refrigerator of the present invention comprises a main body defining the external appearance thereof and having an opened front surface, and a storage chamber formed in the main body. The storage chamber is divided into right and left chambers forming a freezing chamber (not shown) and a refrigerating chamber 11, and a pair of doors 12 is hinged to both side ends of the main body for respectively opening and closing the freezing chamber and the refrigerating chamber 11.

A compressor 13 for compressing a refrigerant is installed at the rear portion of the lower part of the main body 10, and an evaporator 14 for generating cold air and an air blast fan 15 for circulating the cold air into the freezing chamber and the refrigerating chamber 11 are installed at the rear portion of the upper part of the main body 10. A plurality of racks 16 for divisionally storing goods to be stored are arranged in the freezing chamber and the refrigerating chamber 11, and a plurality of door racks 12a for storing cans or beverage bottles are installed on the inner walls of the doors 12.

A dispenser 20 for discharging ice and water therethrough is formed in the door 12 for opening and closing the freezing chamber, and an opening 12b for allowing a user to put or take stored goods into and out of the refrigerating chamber 10 without opening the door 12 and an auxiliary door 30 for opening and closing the opening 12b are formed in the door 12 for opening and closing the refrigerating chamber 11. A receipt case 12c for reducing the leakage of cold air through the opening 12b when the opening 12b is opened is installed on the door rack 12a installed on the inner wall of the auxiliary door 30.

The auxiliary door 30 is installed such that the lower end of the auxiliary door 30 is rotatably connected to the lower end of the opening 12b of the door 12, so that the auxiliary door 30 is vertically rotated to open and close the opening 12b, and is opened such that the rear surface of the auxiliary door 30 meets the front surface of the door 12 at an angle of 90°, so that the goods can be laid on the rear surface of the auxiliary door 30.

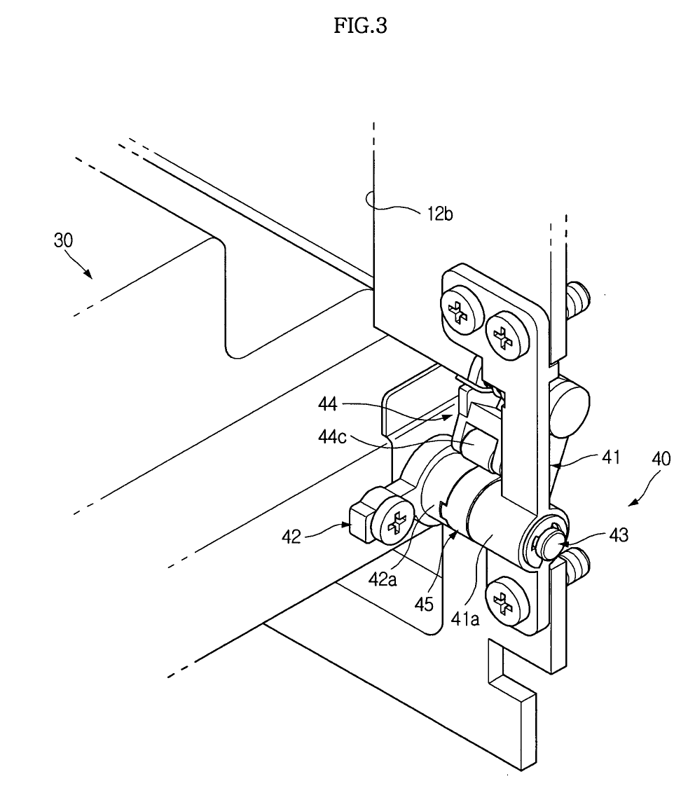

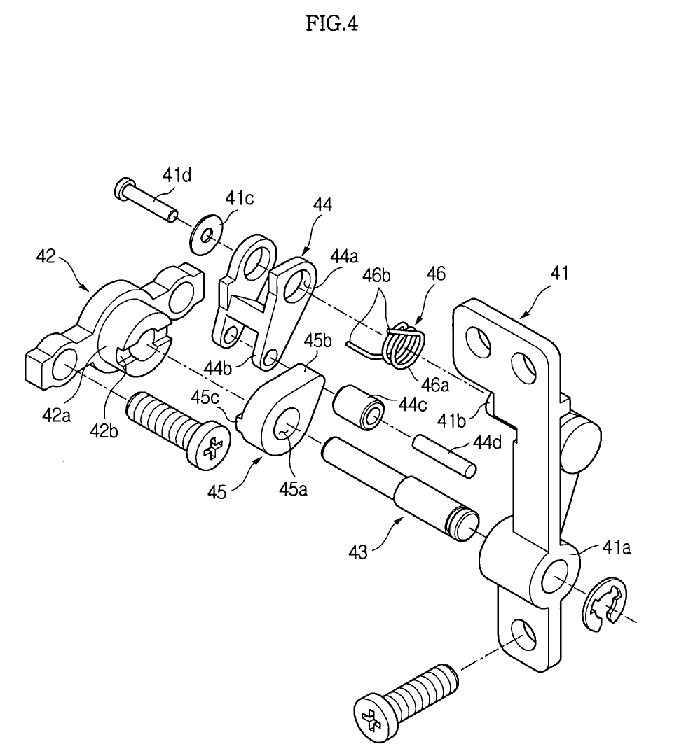

In order to rotatably install the auxiliary door 30 at the opening 12b of the door 12, hinge devices 40, as shown in FIGS. 3 and 4, are provided at both sides of the opening 12b of the door 12. Each of the hinge devices 40 comprises a first fixing bracket 41 fixed to one side of the opening 12b of the door 12 by a connection member, such as a screw, a second fixing bracket 42 fixed to one side of the auxiliary door 30 by a connection member, such as a screw, and a hinge shaft 43 provided with one end rotatably installed at the first fixing bracket 41 and the other end rotatably installed at the second fixing bracket 42. A first hinge portion 41a is formed on the first fixing bracket 41 and is provided with a hole in which one end of the hinge shaft 43 is rotatably installed, and a second hinge portion 42a is formed on the second fixing bracket 42 and is provided with a hole in which the other end of the hinge shaft 43 is rotatably installed. Thereby, the auxiliary door 30 is rotatably installed at the opening 12b of the door 12 through the hinge shaft 43.

In order to decrease impact occurring when the auxiliary door 30 is completely opened, the hinge device 40 applied to the refrigerator of the present invention reduces the increase in the opening speed of the auxiliary door 30 from the point of time when the auxiliary door 30 has been opened to a designated angle.

For this reason, the hinge device 40 further comprises a first cam member 44 rotatably installed at one side of the opening 12b of the door 12, a second cam member 45 installed on the auxiliary door 30, rotated together with the rotation of the auxiliary door 30, and contacting the first cam member 44 according to the opening angle of the auxiliary door 30, and an elastic member 46 installed in the first cam member 44 for elastically supporting the first cam member 44 in the circumferential direction.

The first cam member 44 includes a first through-hole 44a for causing the first cam member 44 to be rotatably connected to a cam shaft 41b extended from the first fixing bracket 41, and a first cam portion 44b having the shape of a wedge and protruding in the anti-radial direction for interacting with the second cam member 45. A washer 41c and a fixing pin 41d are installed at the front end of the cam shaft 41b, thereby preventing the first cam member 44 from being separated from the cam shaft 41b. A bush 44c having the shape of a ring, for reducing friction between the first cam portion 44b and the second cam member 45 so that the second cam member 45 is smoothly rotated together with the rotation of the auxiliary door 30 even when the second cam member 45 contacts the front end of the first cam portion 44b, is rotatably installed at the front end of the first cam portion 44b by a pin 44d.

The elastic member 46 is a torsion spring including an elastic portion 46a having the shape of a coil and exhibiting elastic force in the circumferential direction, and a pair of support portions 46b respectively extended from both ends of the elastic portion 46a. One of the support portions 46b is fixed by the first fixing bracket 41, and the other one of the support portions 46b is fixed by the first cam member 44, thus elastically supporting the first cam member 44 in the circumferential direction.

The second cam member 45 includes a second through-hole 45a for passing the hinge shaft 43, and a second cam portion 45b having the shape of a wedge and protruding in the anti-radial direction so that the second cam portion 45b contacts the first cam portion 44b due to the opening of the auxiliary door 30. A clutch hole 45b for causing the second cam member 45 to be rotated together with the rotation of the auxiliary door 30 is formed in the second hinge portion 42a, and a clutch protrusion 45c is formed on one surface of the second cam member 45, so that the second cam member 45 is rotated together with the rotation of the auxiliary door 30 by the clutch hole 42b and the clutch protrusion 45c.

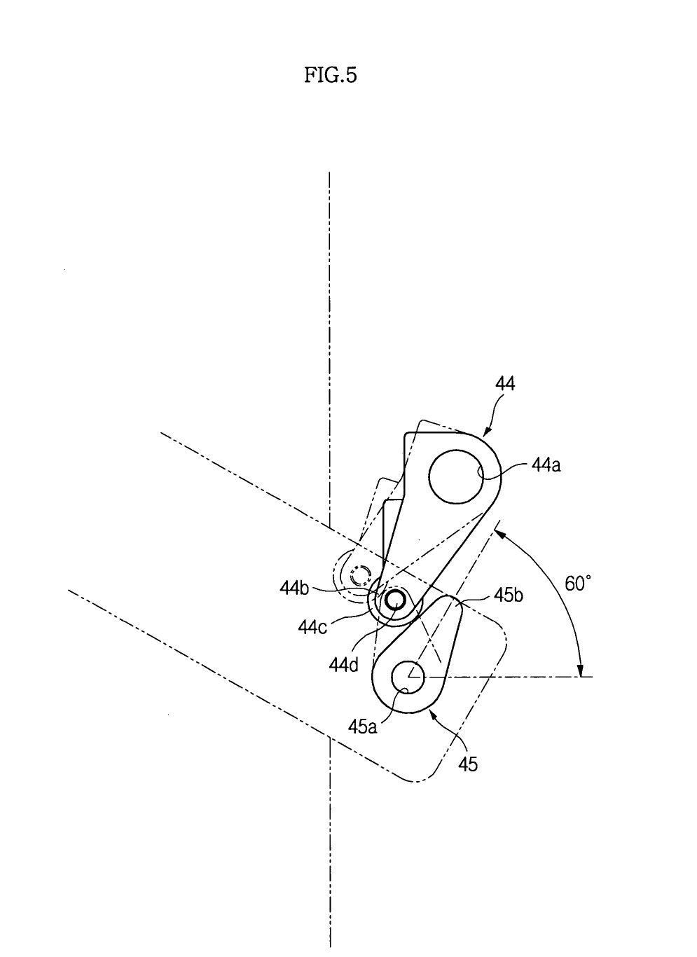

When the auxiliary door 30 starts to be opened by a user, the opening speed of the auxiliary door 30 is gradually increased due to gravity until the auxiliary door 30 is opened to a designated angle. Then, from the point of time when the auxiliary door 30 is opened above the designated angle, as shown in FIG. 5, the second cam portion 45b contacts the first cam portion 44b, and at least a part of gravity, which was used to open the auxiliary door 30, is used to elastically deform the elastic member 46 elastically supporting the first cam member 44, thereby reducing or stopping the increase in the opening speed of the auxiliary door 30. That is, when the auxiliary door 30 is opened in the range of the designated angle, the first cam member 44 and the second cam member 45 are separated from each other, and when the auxiliary door 30 is opened outside the above range, the auxiliary door 30 is elastically supported by the first cam member 44 through the second cam member 45. Thereby, the increase in the opening speed of the auxiliary door 30 is reduced or stopped.

In this embodiment, when the auxiliary door 30 is opened at an angle of 60°, the first cam portion 44b and the second cam portion 45b start to contact each other. That is, when the auxiliary door 30 is opened from an angle of 0° to an angle of 60°, the opening speed of the auxiliary door 30 is gradually increased due to gravity, and when the auxiliary door 30 is opened from an angle of 60° to an angle of 90°, the auxiliary door 30 is elastically supported by the elastic member 46 so that the increase in the opening speed of the auxiliary door 30 is reduced or stopped.

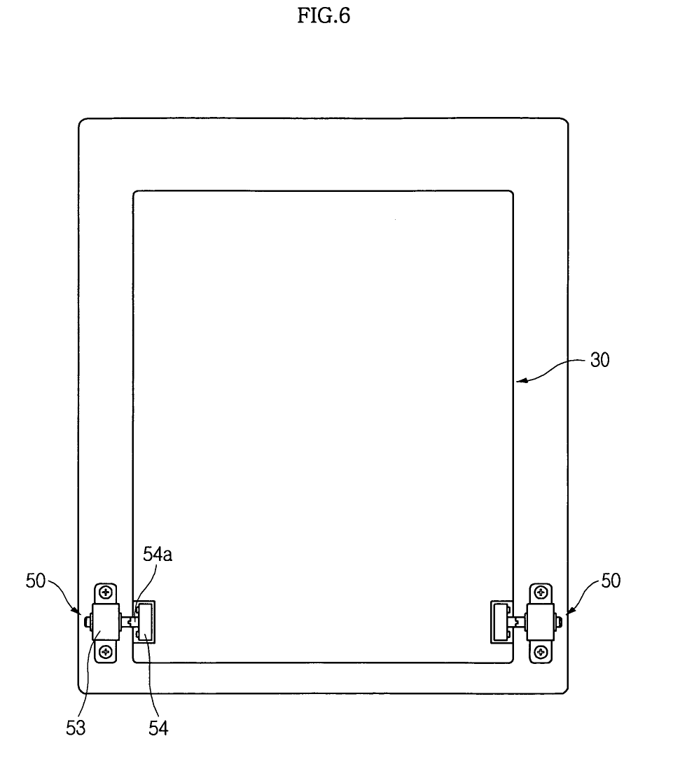

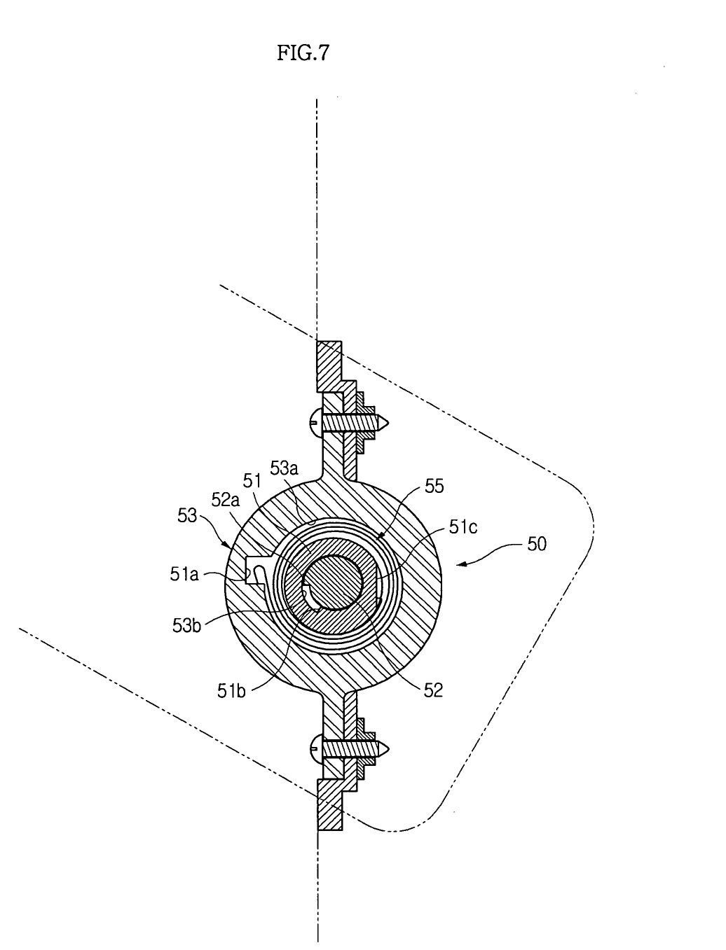

Hereinafter, a hinge device applied to a refrigerator in accordance with the second embodiment of the present invention will be descried with reference to the FIGS. 6 and 7.

The hinge device 50 of the second embodiment comprises a first cam member 51 rotatably installed at one side of the opening 12b of the door 12, and a second cam member 52 installed on the auxiliary door 30 to be rotated together with the rotation of the auxiliary door 30 and interacting with the first cam member 51 according to the opening angle of the auxiliary door 30.

In order to install the first cam member 51, a first fixing bracket 53 provided with a hinge hole 53a for rotatably installing the first cam member 51 therein is provided at one side of the opening 12b of the door 12, and in order to install the second cam member 52, a second fixing bracket 54 provided with a hinge protrusion 54a is provided at one side of the auxiliary door 30. Here, an elastic member 55 for elastically supporting the auxiliary door 30 according to the opening angle of the auxiliary door 30 is installed in the first cam member 51.

A cam hole 51a for rotatably installing the second cam member 52 therein is formed in the first cam member 51, and a first cam portion 51b contacting the second cam member 52 according to the opening angle of the auxiliary door 30 is protruded from the inner cylindrical surface of the cam hole 51a.

A second cam portion 52a is protruded from the outer cylindrical surface of the second cam member 52 so that the second cam portion 52a is installed on the hinge protrusion 54a to be rotated together with the rotation of the auxiliary door 30 and contacts the first cam portion 51b according to the opening angle of the auxiliary door 30. A clutch protrusion (not shown) is formed on one side of the second cam member 52 and a clutch hole (not shown) is formed in the hinge protrusion 54a so that force is transmitted from the second cam member 52 to the hinge protrusion 54a.

The elastic member 55 is a plate spring wound several times on the outer cylindrical surface of the first cam member 51. One end of the elastic member 55 is latched onto a first latch portion 53b formed in the first fixing bracket 53, and the other end of the elastic member 55 is latched onto a second latch portion 51c formed in the outer cylindrical surface of the first cam member 51, thereby elastically supporting the first cam member 51 in the circumferential direction.

Since the second cam member 52 is freely rotated in the cam hole 51a until the auxiliary door 30 is opened to a designated angle, the opening speed of the auxiliary door 30 is gradually increased. Then, since the first cam portion 51b and the second cam portion 52a contact each other from the point of time when the auxiliary door 30 is opened to the designated angle, the first cam member 51 is rotated in the hinge hole 53a of the first fixing bracket 53 together with the rotation of the second cam member 52. At this time, since the first cam member 51 is elastically supported in the circumferential direction by the elastic member 55, at least a part of gravity applied to the auxiliary door 30 is used to elastically deform the elastic member 55, thereby causing the increase in the opening speed of the auxiliary door 30 to be reduced or stopped.

As apparent from the above description, the present invention provides a refrigerator having a hinge device, for hinging an auxiliary door to an opening of a door, which elastically supports the auxiliary door from the point of time when the auxiliary door is opened to a designated angle. The opening speed of the auxiliary door is gradually increased until the auxiliary door is opened to the designated angle, and is decreased due to the elastic support of the auxiliary door by the hinge device from the point of time when the auxiliary door is opened above the designated angle. Thereby, the hinge device reduces impact applied to the auxiliary door when the auxiliary door is completely opened.

Although exemplary embodiments of the invention have been shown and described, it will be appreciated by those skilled in the art that changes may be made in these embodiments without departing from the principles and spirit of the invention, the scope of which is defined in the claims and their equivalents.

What is claimed is:

1. A refrigerator comprising:
a main body, one surface of which is opened, provided with a storage chamber therein;
at least one door for opening and closing the storage chamber;
an opening formed through the door;
an auxiliary door, a lower end of which is rotatably installed at a lower end of the opening of the door, for opening and closing the opening; and
a hinge device which rotatably mounts the auxiliary door at the opening, and elastically supports the auxiliary door from a point of time when the auxiliary door is opened to a designated angle to reduce the opening speed of the auxiliary door.

2. The refrigerator as set forth in claim 1, wherein the hinge device comprises a first cam member rotatably installed at one side of the opening and elastically supported by an elastic member exhibiting elastic force, and a second cam member installed on the auxiliary door, rotated together with the rotation of the auxiliary door and contacting the first cam member to transmit force to the first cam member from the point of time when the auxiliary door is opened to the designated angle.

3. The refrigerator as set forth in claim 2, wherein the hinge device further comprises a first fixing bracket fixed to one side of the opening of the door such that the first cam member is rotatably installed on the first fixing bracket, a second fixing bracket fixed to the auxiliary door such that the second cam member is installed on the second fixing bracket, and a hinge shaft passing through the first cam member and provided with one end rotatably installed at the first fixing bracket and an other end rotatably installed at the second fixing bracket.

4. The refrigerator as set forth in claim 2, wherein a first cam portion and a second cam portion are respectively protruded from the first cam member and the second cam member in the anti-radial direction, and contact each other from the point of time when the auxiliary door is opened to the designated angle.

5. The refrigerator as set forth in claim 3, wherein the elastic member includes a torsion spring comprising an elastic portion having the shape of a coil and exhibiting elastic force in the circumferential direction, and a pair of support portions respectively extended from both ends of the elastic portion and fixed to the first fixing bracket and the first cam member.

6. The refrigerator as set forth in claim 2, wherein a cam hole for rotatably installing the second cam member therein is formed in the first cam member, and a first cam portion and a second cam portion, which contact each other according to the rotation of the auxiliary door, are respectively protruded from an inner cylindrical surface of the cam hole and an outer cylindrical surface of the second cam member.

7. The refrigerator as set forth in claim 6, wherein the hinge device further comprises a first fixing bracket fixed to one side of the opening of the door and provided with a hinge hole for rotatably installing the first cam member therein, and a second fixing bracket fixed to one side of the auxiliary door and provided with the second cam member installed thereon for rotating the second cam member together with the rotation of the auxiliary door.

8. The refrigerator as set forth in claim 7, wherein the elastic member includes a plate spring wound on an outer cylindrical surface of the first cam member, and provided with one end latched onto a first latch portion formed in an inner cylindrical surface of the first fixing bracket and an other end latched onto a second latch portion formed in the outer cylindrical surface of the first cam member.

9. A refrigerator comprising:
a main body, one surface of which is opened, provided with a storage chamber therein;
at least one door for opening and closing the storage chamber;
an opening formed through the door;
an auxiliary door, a lower end of which is rotatably installed at a lower end of the opening of the door, for opening and closing the opening; and
a hinge device which rotatably mounts the auxiliary door on the door,
wherein the hinge device comprises a first cam member rotatably installed at one side of the opening of the door, a second cam member installed at one side of the auxiliary door, rotated together with the rotation of the auxiliary door, and contacting the first cam member according to the opening angle of the auxiliary door, and an elastic member for elastically supporting the first cam member in a circumferential direction.

10. The refrigerator as set forth in claim 9, wherein the hinge device further comprises a first fixing bracket fixed to one side of the opening of the door such that the first cam member is rotatably installed on the first fixing bracket, a second fixing bracket fixed to the auxiliary door such that the second cam member is installed on the second fixing bracket, and a hinge shaft passing through the first cam member and provided with one end rotatably installed at the first fixing bracket and an other end rotatably installed at the second fixing bracket.

11. The refrigerator as set forth in claim 9, wherein a first cam portion and a second cam portion are respectively protruded from the first cam member and the second cam member in the anti-radial direction, and contact each other from a point of time when the auxiliary door is opened to a designated angle.

12. The refrigerator as set forth in claim 10, wherein the elastic member includes a torsion spring comprising an elastic portion having the shape of a coil and exhibiting elastic force in the circumferential direction, and a pair of support portions respectively extended from both ends of the elastic portion and fixed to the first fixing bracket and the first cam member.

13. The refrigerator as set forth in claim 9, wherein a cam hole for rotatably installing the second cam member therein is formed in the first cam member, and a first cam portion and a second cam portion, which contact each other according to the rotation of the auxiliary door, are respectively protruded from an inner cylindrical surface of the cam hole and an outer cylindrical surface of the second cam member.

14. The refrigerator as set forth in claim 13, wherein the hinge device further comprises a first fixing bracket fixed to one side of the opening of the door and provided with a hinge hole for rotatably installing the first cam member therein, and a second fixing bracket fixed to one side of the auxiliary door and provided with the second cam member installed thereon for rotating the second cam member together with the rotation of the auxiliary door.

15. The refrigerator as set forth in claim 14, wherein the elastic member includes a plate spring wound on an outer cylindrical surface of the first cam member, and provided with one end latched onto a first latch portion formed in an inner cylindrical surface of the first fixing bracket and an other end latched onto a second latch portion formed in the outer cylindrical surface of the first cam member.

16. The refrigerator as set forth in claim 14, wherein a bush having the shape of a ring, for allowing the second cam member to be smoothly rotated even when the second cam member contacts a front end of the first cam portion, is installed at the front end of the first cam portion.

17. A refrigerator comprising:
a main body, one surface of which is opened, provided with a storage chamber therein;
at least one door for opening and closing the storage chamber;
an opening formed through the door;
an auxiliary door, a lower end of which is rotatably installed at a lower end of the opening of the door, for opening and closing the opening; and
a hinge device which rotatably mounts the auxiliary door at the opening, and elastically supports the auxiliary door from a point of time when the auxiliary door is opened to a designated angle to reduce the opening speed of the auxiliary door,
wherein the hinge device comprises a first cam member provided with a first cam portion having the shape of a wedge and installed at one side of the opening, and a second cam member provided with a second cam portion having the shape of a wedge and installed at one side of the auxiliary door so that the second cam portion contacts the first cam portion when the auxiliary door is opened outside a designated range.
